(19) United States
(12) Patent Application Publication
(10) Pub. No.: US 2013/0171494 A1
(43) Pub. Date: Jul. 4, 2013

(54) CONTACT ELEMENT FOR DIVERTERS OF ELECTROCHEMICAL CELLS

(71) Applicants: Tim Schaefer, Harztor (DE); Steffen Legner, Ellwangen (DE)

(72) Inventors: Tim Schaefer, Harztor (DE); Steffen Legner, Ellwangen (DE)

(73) Assignee: Li-Tec Battery GmbH, Kamenz (DE)

(21) Appl. No.: 13/637,683

(22) PCT Filed: Mar. 28, 2011
(86) PCT No.: PCT/EP2011/001550

§ 371 Date: Mar. 4, 2013

(30) Foreign Application Priority Data
Mar. 30, 2010 (DE) 102010013351.5

(51) Int. Cl. H01M 2/20

(52) U.S. Cl. CPC H01M 2/20
USPC 429/121; 29/874

(57) ABSTRACT

What is proposed is a contact element for connection between electrically conducting, preferably plate-shaped, components, in particular diverters of electrochemical cells, consisting of different materials, wherein the contact element is produced from at least two elements (32, 34), wherein at least two elements are joined by means of laser induction rollers, wherein a first element is adapted for connection to a first of the electrically conducting components, wherein a second element is adapted for connection to a second of the electrically conducting components, and wherein the first and the second element have an electrically conducting connection to one another. Therefore, a connection with high process reliability can be provided between diverters of electrochemical cells.

The present invention concerns contact elements (cell connectors or contact links) for current connectors of electrochemical cells (battery or accumulator cells).

In battery construction it is desirable when interconnecting a plurality of electrochemical cells, and in particular flat battery cells with flat current connectors, to connect the current connectors permanently to form a battery block (series and/or parallel connection). The current connectors of battery cells typically consist of different materials, such as copper and/or nickel and aluminium, or alloys of these metals. The problem therefore exists of joining together incompatible materials of different types. Connection methods used include e.g. ultrasonic welding, laser welding, adhesive bonding or soldering. Operationally reliable connections, however, can in general only be achieved with the same material combination.

From EP 1 779 962 A1 for example, a method for direct welding of current connectors by means of contiguous welding points is known. The wedge-shaped welding points are applied by means of a laser beam from the side of the electrode with the lower melting point.

From DE 10 2008 036 435 A1 and EP 2 090 395 A2, identical in terms of content, a method and a device are known for the effective production of metallic composites and composite semi-finished products in tape form, in particular for all material combinations which are either difficult or impossible to fusion-weld, such as quenched and tempered steel/mild steel, roller-bearing steel/mild steel, stellites/mild steel, steel/aluminium, titanium/steel, titanium/aluminium, etc., using a method known as “laser-induction roll-bonding”. This is done by an inhomogeneous short-term heating of at least one of the tapes to be connected as a result of a simultaneous energy input by electromagnetic induction and laser irradiation, the laser being applied directly onto a reforming zone on the inside of the tape or immediately before a rolling process, while at the same time a hot rolling of the tapes or of the semi-finished product takes place in one rolling pass with a true strain of between 2 and 70%.

In addition, reference is made to DE 37 13 975 A1, in which the production of overlapping seams between sheets, tapes or panels with a similar method is described, with application of pressure being provided in front of, but not in the jointing area.

From EP 1 550 834 A1 and U.S. Pat. No. 6,300,591 B1 methods are known for welding copper pipes to an aluminium plate by means of laser beams with simultaneous application of pressure, e.g. by a pressure roller.

JP 2001-087866 A1 describes the production of an overlapping weld seam of copper and aluminium components, such as represented by the current connectors of lithium secondary batteries. In this process, the copper component is first tin plated and then welded under compression by means of an electrode having a flat tungsten tip on the copper side and a dome-shaped electrode on the aluminium side.

U.S. Pat. No. 4,224,499 A relates to a method for butt welding a copper and an aluminium conductor, wherein the contact area is melted by laser light and the mating surfaces are pressed against each other.

The above cited methods are not applicable to the direct connection of current connectors of battery cells, for process-engineering reasons.

An object of the present invention is to improve the prior art, in particular (but not only) with regard to the above-mentioned aspects.

The object is achieved by means of the features of the independent claims. Advantageous extensions of the invention form the subject matter of the dependent claims.

In accordance with one aspect of the invention, a contact element is proposed for connecting between, preferably plate-shaped, electrically conducting components, in particular current connectors of electrochemical cells, consisting of different materials, wherein the contact element is produced from at least two segments, with at least two segments being joined by means of laser induction rolling, wherein a first segment is adapted for connection to a first of the electrically conducting components and a second segment is adapted for connection to a second of the electrically conducting components, and wherein the first and the second segment have an electrically conducting connection to each other.

An electrochemical energy cell in the context of the invention can be understood as meaning any device which is also designed and equipped for supplying electric energy. It may thus involve in particular, but not only, an electrochemical storage cell of the primary or secondary type (battery or accumulator cell), a fuel cell or a capacitor cell. Particularly preferably, but not exclusively, the invention is applicable to flat accumulator cells, the electrochemically active parts of which have, e.g., a film stack or a film winding, are surrounded by a gas-tight, vapour-tight and liquid-tight sheath and are connected to current connectors which pass outwards through the sheath and project from the cell in planar form. An electrochemically active part is in this context understood to mean that part within which charging, discharging and possibly conversion processes of electrical energy take place. The active part can have film layers made of electrochemically active materials (electrodes), conductive materials (current collectors) and isolating materials (separators).

A contact element in the context of the invention can be understood as meaning a component that is arranged between current connectors of two electrochemical cells and produces a contacting of the current connectors.

Laser induction rolling within the context of the invention can be understood as meaning a method in which two workpieces, preferably in tape form, are inductively preheated and pressed onto each other so that they at least partially overlap, e.g. by pressure rolling or pressure rollers, and in a joining area of the workpieces a further heating takes place by laser light, preferably—but not necessarily—until melting occurs. Laser light can be understood as meaning electromagnetic radiation of any wavelength which is suitable for heating the materials to be joined.

The contact element is produced according to the invention from at least two segments, with at least two segments being joined using laser induction rollers. This includes the possibility that exactly two segments are joined by Laser induction rolling, and also the possibility that, for example, three segments are present, with all segments being joined by laser induction rolling, or only two segments are joined by laser induction rolling while another segment is joined to one of the two aforementioned segments by another method. Designs with more than three segments are also possible.

With the method of laser induction welding, materials can also be joined to each other which are difficult to join by conventional methods. A contact element which is produced in the manner described can have segments made from materials which are difficult to join to one another, which are adapted to the electrically conducting components to be joined.

The contact element is preferably designed such that the first segment forms a material combination with the first electrically conducting component which is adapted to a thermal joining process, and the second segment forms a material combination with the second electrically conducting component which is adapted to a thermal joining process. By this method a connection process of the components to be connected can also be implemented easily and economically, and an operationally reliable connection created.

In particular, the contact element is designed such that the first and/or the second segment has an electrically conducting metal or an electrically conducting metal alloy. Metals have good mechanical and electrical properties. The seam of the metallic segments produced by the laser induction rollers can also have good conductivity and a low contact resistance.

Particularly preferably, the contact element is designed such that the first or the second segment comprises aluminium or an aluminium alloy, or a conducting material which can be easily joined to aluminium or an aluminium alloy. A current connector of an electrochemical cell is often made from aluminium or an aluminium alloy. If one of the first and second segments comprises aluminium or an aluminium alloy, or a conducting material which can be easily joined to aluminium or an aluminium alloy, this can also facilitate a simple and economical production of an operationally reliable connection to the current connector.

In addition, the contact element is particularly preferably designed such that the other of the first and second segment comprises copper or copper alloy or a material which joins well to copper. A current connector of an electrochemical cell is often produced from copper or a copper alloy. If one of the first and second segments comprises copper or a copper alloy or a conducting material which joins well to copper or a copper alloy, an operationally reliable connection to the current connector can also be produced simply and economically.

In a particularly preferred configuration the contact element is configured such that the first and the second segment are each substantially plate-shaped and preferably have an overlapping seam with each other, wherein each of the first and second segment is angled beyond the seam in order to form, at least substantially, a U-shaped cross-section. A U-shaped cross-section is characterized by two at least substantially parallel legs. If the contact element has an at least substantially U-shaped cross-section, parallel electrically conductive, and in particular plate-shaped, components can also be easily connected to the contact element. Since current connectors of electrochemical cells often comprise parallel, plate-shaped conductors, current connectors of electrochemical cells can also be easily interconnected with the contact element.

In an alternative configuration the contact element is implemented such that the first and the second segment are each substantially plate-shaped, have a preferably overlapping seam with each other and define a common, at least substantially even surface, wherein preferably at least one of the first and second segments is bent at right angles on the far side of the seam. If the segments define a single, at least substantially even surface, plate-shaped components, in particular those which are aligned with each other, can also be easily connected to the contact element. If the current connectors of electrochemical cells are angled, current connectors of electrochemical cells can also be easily interconnected with the contact element. An even surface of the segments can be provided, for example, by bending at least one of the first and second segments at right angles beyond the seam. In the case of contact elements consisting of more than two segments, wherein at least a third segment is arranged between the first and the second segment, the bending can be omitted where appropriate.

In particular, the contact element is designed such that an electrically conducting connection is realised between the first and the second segment by directly adjoining them. Such a design also facilitates a permanent and secure electrical connection.

In an alternative configuration the contact element is designed such that the first and the second segment are electrically isolated from each other by at least one third segment comprising a non-conducting material, and an electrically conducting connection between the first and the second element is able to be detached, preferably multiple times, and restored. Using such a configuration, a mechanical connection can be produced between electrically conducting components while an electrical connection is only made at a deployment site or in a final assembly, or on activation of the device.

In a further configuration the contact element can be designed such that the first and the second segment are connected by at least one third segment, arranged between the first and the second segment, wherein the third segment has a non-conducting substrate layer and an electrically conducting conductor layer. With such a configuration the total weight of the contact element and the quantity of conductor material consumed can also be reduced.

The conductor layer can have interruptions, or in general form a conductor pattern. Thus, by means of additional connection means such as wires, clips or the like, a separable and reproducible electrical connection can be created between the components to be connected. In general, the conductor pattern can be designed to accommodate electrical components such as switches, integrated circuits, diodes, resistors, capacitors, sensors, or the like, in order to control a connection condition between components to be connected, in particular current connectors of electrochemical cells, and also to monitor and control a condition of devices connected to the components to be connected, in particular a condition of electrochemical cells with regard to, for example, but not only, temperature, charge, voltage or the like. The conductor pattern can have in particular, without limitation of generality, a printed circuit.

In accordance with another aspect of the invention, a method for producing a contact element for connecting between, preferably plate-shaped, electrically conducting components, in particular current connectors of electrochemical cells, consisting of different materials is proposed, having the steps: preparing a first electrically conducting segment such that it is adapted for connection to a first of the electrically conducting components, preparing a second electrically conducting segment such that it is adapted for connection to a first of the electrically conductive components, joining the segments to each other directly or via at least one other segment by means of laser induction rolling, wherein the first and the second segment have an electrically conducting connection to each other.

In accordance with a further aspect of the invention, a method for connecting, preferably plate-shaped, electrically conducting components, in particular current connectors of electrochemical cells, consisting of different materials, is created having the steps: preparing a contact element produced according to the above method with at least two segments, connecting the first segment to a first electrically conducting component to be connected, and connecting the second segment to a second electrically conducting component to be connected.

In accordance with a further aspect of the invention, an arrangement of electrochemical cells is proposed, wherein the electrochemical cells have current connectors which have different conductor materials, wherein current connectors of different cells are connected to contact elements according to any one of the preceding claims or by a method according to any one of the preceding claims.

### BRIEF DESCRIPTION OF THE DRAWINGS

The above and other features, objects and advantages of the present invention will become clearer from the following description, which has been prepared with reference to the enclosed drawings.

The drawings show:

FIG. 1 a schematic view of a device used to connect two workpiecess by means of laser induction rollers;

FIG. 2 a schematic perspective view of a semi-finished product joined by laser induction rollers as an intermediate result of a method for producing a contact element in an exemplary embodiment of the present invention;

FIG. 3 a schematic perspective view of an intermediate product in the method for producing a contact element;

FIG. 4 a schematic perspective view of a contact element according to an exemplary embodiment of the present invention as a final product of a method for producing a contact element;

FIG. 5 a schematic side view of two electrochemical cells, the current connectors of which are connected to the contact element of FIG. 4;

FIG. 6 a schematic side view of a contact element of a further exemplary embodiment of the present invention;

FIG. 7 a schematic side view of a contact element according to a further exemplary embodiment of the present invention;

FIG. 8 a schematic sectional view of a contact element according to a further exemplary embodiment of the present invention; and

FIG. 9 a schematic perspective representation of a contact element according to a further exemplary embodiment of the present invention.

It should be pointed out that the representations in the Figures are schematic and restricted to the reproduction of the features most important for understanding the invention. It should also be noted that the dimensions and proportions reproduced in the figures are solely intended for clarity of illustration and to be understood as by no means limiting, unless otherwise indicated by the description.

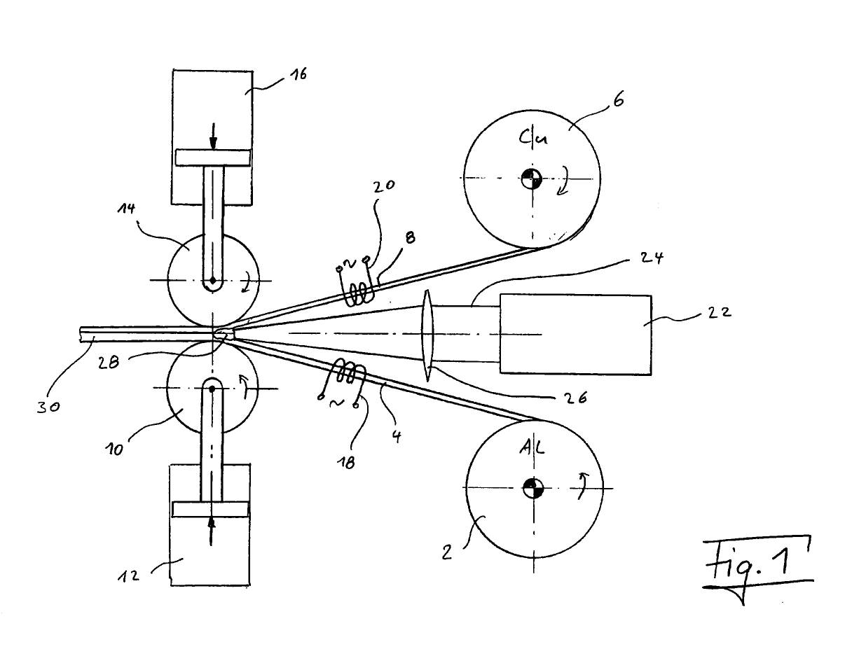

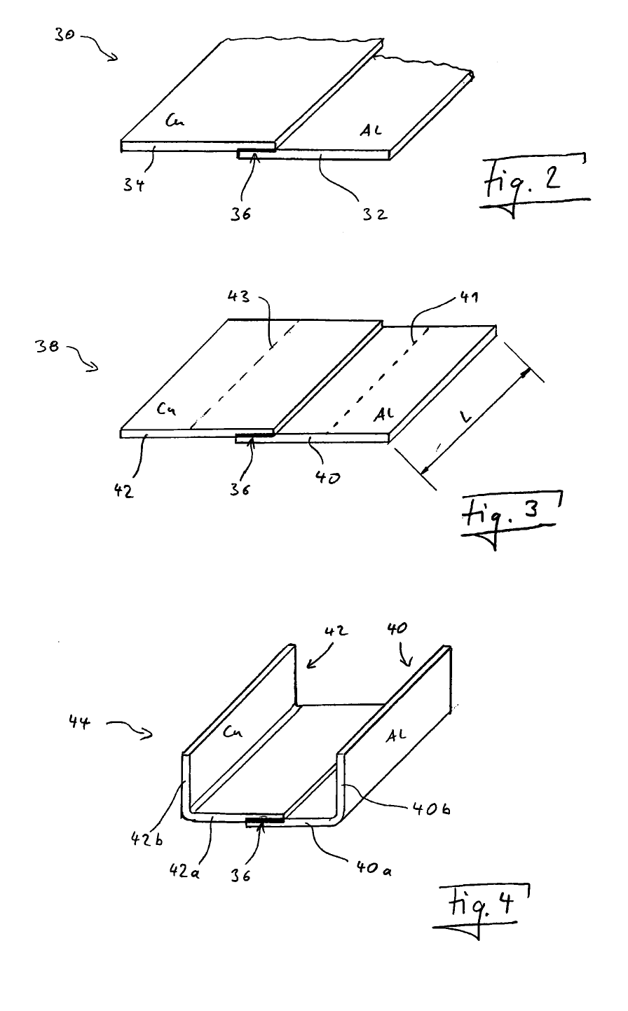

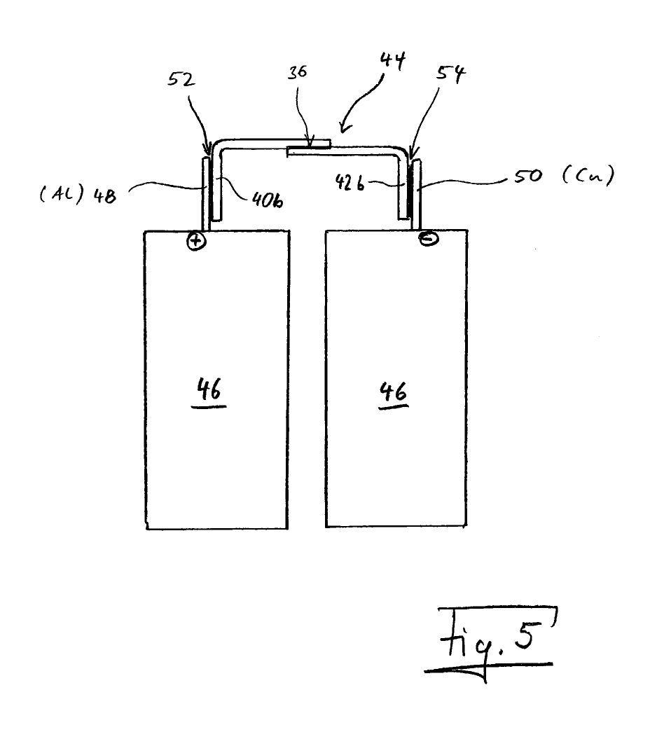

Below, by reference to FIGS. 1 to 4, a plurality of steps of a method in the production of a contact element are described, up to the final product according to a preferred exemplary embodiment of the present invention. Thus, FIG. 1 shows a device for laser induction welding of two workpieces to form a semi-finished product, FIG. 2 shows a schematic perspective view of the semi-finished product as a result of the processing according to the laser induction welding in, FIG. 3 shows an intermediate product in the same view after cutting the semi-finished product of FIG. 2 to length, and FIG. 4 shows the finished contact element in the same view.

In accordance with the illustration in FIG. 1, a device for laser induction welding comprises a first reel 2 on which a first tape 4 of an aluminium material (Al) is wound, a second reel 6 on which a second tape 8 of a copper material (Cu) is wound, a first pressure roller which is functionally connected to a first pressure cylinder, a second pressure roller 14 functionally connected to a second pressure cylinder 16, a first induction heating coil 18, a second induction heating coil 20, a laser source 22 for emmiting a laser beam 24 and a lens 26 for focusing the laser beam 24.

As already mentioned, on the first reel 2 a first tape 4 of an added aluminum material (Al) is wound. The first reel 2 is rotatably mounted such that the first tape 4 can be drawn off it. In the same way, the second reel 6, on which the second tape 8 of the copper material is wound, is rotatably mounted such that the second tape can be drawn off it. To simplify the presentation, devices such as roller guides and feeding devices for the first tape 4 and the second tape 8 are omitted from the drawing. These devices ensure that the first tape 4 and the second tape 8 are guided smoothly and uniformly and kept straight.

The first tape 4 and the second tape 8 are passed between the first pressure roller 10 and the second pressure roller 14, wherein by the action of the first pressure cylinder 12, which is functionally coupled with the first pressure roller 10, and of the second pressure cylinder 16, which is functionally coupled with the second pressure roller 14, the first tape 4 and the second tape 8 are pressed against each other. It is hereby provided that the first tape 4 and the second tape 8 do not fully overlap, but have a lateral offset, so that only a part of the width of the first tape 4 overlaps with part of the width of the second tape 8.

Before entering an area between the two rollers 10, 14, the first tape 4 is introduced through the first induction heating coil 8. Similarly, the second tape 8 is fed through a second induction heating coil 20 before entering the area between the two rollers 10, 14. By controlling the induction heating coils 18, 20 with a suitable current, the first tape 4 and the second tape 8 are heated.

It should be noted at this point that the representation of the induction heating coils 18, 20 is to be understood purely schematically, and as an example of a device for inductive heating. In a design variant, instead of being guided through the induction heating coils 18, 20, the tapes 4, 8 can be guided past them. In other variations, a plurality of heating coils 18, 20 can each be arranged one behind the other, opposite to, or surrounding the tape 4 or 8 respectively.

The lens 26 casts the laser light (laser beam 24) emitted by the laser source 22 onto the point at which the first tape 4 pre-heated by the first induction heating coil 18 and the second tape 8 pre-heated by the second induction heating coil 20 meet between the pressure rollers 10, 14.

Through the effect of the laser beam 24 the first tape 4 and the second tape 8 are heated up in a melting zone 28 to such an extent that they fuse together under the pressure exerted by the pressure rollers 10, 14. It should be noted here that the materials of the first tape 4 and the second tape 8 need not be brought fully to the molten liquid state if the materials of the first tape 4 and the second tape 8 securely connect together under pressure and heat.

The joined semi-finished product 30 made from the first tape 4 and the second tape 8 is drawn off on the far side of the pressure rollers 10, 14 and wound onto a reel or directly cut to length as appropriate.

The materials of the first tape 4 or the second tape 8, referred to as aluminium material (Al) and copper material (Cu), can involve comparatively pure materials as well as alloys. The aluminium material of the first tape 4 is, in particular, a material comprising aluminum which joins well with an aluminum material of a positive current connector of an electrochemical cell. Likewise, the copper material of the second tape 8 is a material which joins well with a copper material of a negative current connector of an electrochemical cell.

In FIG. 2 the semi-finished product 30 formed in the step shown in FIG. 1 of the laser induction rolling is shown in a schematic perspective view from an end face. The semi-finished product 30 in accordance with the illustration in FIG. 2 has a first strand 32 and a second strand 34, which are welded together at a seam 36. The first strand 32 is formed from the first tape 4 while the second strand 34 is formed from the second tape 8. Consequently, the first strand 32 comprises the aluminium material, while the second strand 34 comprises the copper material.

FIG. 3 shows an intermediate product 38 produced from the semi-finished 30 product in the same view as in FIG. 2. The intermediate product 38 is produced from the continuous semi-finished product 30 by trimming to a length L. The intermediate product 38 has a first segment 40 and a second segment 42 which are connected together by the seam 36. The first segment 40 comprises the aluminum material, while the second segment 42 comprises the copper material.

A deflection curve 41 is drawn on a surface of the first segment 40 and a deflection curve 43 is marked on a surface of the second segment 42. The deflection curves 41, 43 extend parallel to the seam 36, that is, in the longitudinal direction of the intermediate product 38, and are required in a subsequent method step.

In FIG. 4 a contact element 44 produced by bending of the free ends (also referred to as a contact link 44) is shown in the same view as in FIG. 2 or FIG. 3. The contact link 44 is produced from the intermediate product 38 by the first member 40 being bent upwards at the deflection curve 41, so that a central member 40a, which faces towards the centre-line of the contact link 44, remains in place, while an edge member 40b projects away from it at least substantially perpendicularly, and the second segment 42 being bent along the deflection curve 43, so that a central member 42a, which faces towards the seam 36, remains in place, while an edge member 42b projects perpendicularly therefrom.

FIG. 5 shows a schematic side view of an arrangement of two battery cells 46, 46. These are in particular rechargeable battery cells (therefore, strictly speaking accumulator cells) of the lithium-ion type or lithium-polymer type. Each cell 46 has a positive current connector 48 and a negative current connector 50. In the selected view, in each case only either the positive current connector 48 or the negative current connector 50 of a battery cell 46 is visible. The positive current connector 48 is produced from an aluminium material, while the negative current connector 50 is produced from a copper material.

The positive current connector 48 of the one battery cell 46 is connected to the negative current connector 50 of the other battery cell 46 via the contact link 44. The angled edge member 40b of the first segment 40 produced from the aluminium material is connected to the positive current connector 48, also produced from an aluminium material, at connection point 52 (positive connection point). Likewise, the edge member 42b of the second segment 42, made of copper material, of the contact link 44 connected to the negative current connector 50, also made of a copper material, of the other battery cell 46 at a connection point 54 (negative connection point).

The connection points 52, 54 can be implemented by thermal methods (welding, laser welding, ultrasonic welding, soldering) or non-thermal methods (adhesive bonding or the like). This advantageously allows the possibility to exploit the fact that the positive or negative current connectors 48, 50 each comprise a combination of materials of the same type as those of the segments 40, 42 of the contact link 44 connected to them. This allows the process of connecting the current connectors 48, 50 to be implemented more easily and more economically and to contribute to a more operationally reliable connection. The seam 36 of the contact link 44 produced by laser induction rolling has a very good conductivity and a low contact resistance.

In addition, the segments 40, 42 of the contact link 44 are designed to be sufficiently thick that a stable cell connector can be produced which can also be used for heat dissipation or cooling.

It should be additionally noted that the side view of the arrangement of battery cells 46 selected in FIG. 5 is an end-on view in relation to the contact element 44 (cf. FIGS. 2 to 4).

Depending on the material of the current connectors 48, 50 of the battery cells 46, the material selection of the segments 40, 42 of the contact link 44 can be optimized with respect to a particularly good joining capability with the material of the respective current connector. Currently, materials made from or with copper, aluminium, or even nickel are preferred.

In a variation not discussed in further detail, the current connectors 48, 50 of the battery cells 46 are bent at right angles at least substantially at the same height, in order to protrude from the battery cells in the stacking direction 46. In such a case the contact links do not have a U-shaped cross-section, as is shown in the exemplary embodiment, but have a plate-shaped cross-section overall. One of the segments is angled such that the segments define a common surface.

In another variation, also not shown in further detail, the current connectors 48, 50 of the battery cells 46 are bent at right angles at different heights, in order to protrude from the battery cells 46 in the stacking direction. For example, the positive current connectors are angled at a higher level than the negative current connectors, or vice versa. In this way, a safe differentiation of the poles of the cell can be facilitated. In such a case, depending on the elevation difference of the current connectors to be overcome, one or both of the segments of the contact link is/are angled such that the contact link has a Z-shaped cross-section.

In another variation, also not shown in further detail, only one of the current connectors 48, 50 of the battery cells 46 is angled, while the other protrudes upwards. In this way also, a safe differentiation of the poles of the cell can be facilitated. In such a case, one of the segments of the contact link is angled and the other segment is straight, so that the contact link has an L-shaped cross-section.

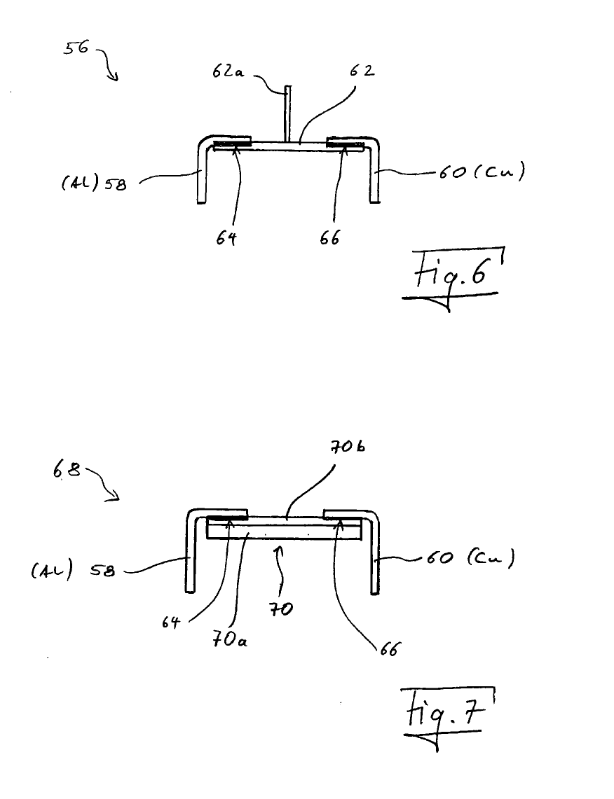

FIG. 6 shows a contact link 56 in a design variant of the present invention in a frontal view.

The contact link 56 of this design variant has a first segment 58, a second segment 60 and a spacer segment 62 (third segment). The first segment 58 and the second segment 60 of this design variant correspond in function and material selection to the segments 40, 42 of the exemplary embodiment described above. The segments 58, 60, however, are not directly connected to each other; rather, the spacer segment 62 is arranged between the first segment and the second segment 60, the first segment being connected to the spacer 62 at a seam 64, while the second segment 60 is connected to the spacer 62 at a seam 66.

The spacer 62 can be made from the same material as one of the segments 58, 60 or from a different material that has a good electrical conductivity. At least one of the seams 64, is produced by the above method of laser induction rolling, while the other of the seams 64, 66 can be produced by another method such as welding, bonding or soldering, if the material combination with the corresponding segment 58, 60, and the expected conditions of use of the contact link 56, are suitable for this purpose.

If necessary however, both seams 64, 66 are produced with the above method of laser induction rolling. It is particularly advantageous if both seams 64, 66 are formed in a single operation by Laser induction rolling.

The spacer segment 62 has a vertically protruding rib 62a, which can improve the stability and/or cooling effect of the contact link 56 and can also be hekpful in handling the contact link 56 when connecting to current connectors of battery cells.

FIG. 7 shows a contact link 68 in another design variant of the present invention in a frontal view.

The contact link 68 of this design variant has a first segment 58 and a second segment 60, which correspond in shape, material selection and function to the first segments 40, 58, or the second segments 42, 60, of the previous contact links 40, 56. In a similar way to the design variant of FIG. 6, a spacer segment 70 is arranged between the first segment 58 and the second segment 60. The spacer segment 70 has a carrier substrate 70a made from a non-conductor material, on which a conductor layer 70b is arranged, which is connected to the first segment 58 at a seam 64 and to the second segment 60 at a seam 66. The connection to the segments 58, 60 is carried out via the conductor layer 70b. For the material selection of the conductor layer 70b, the discussion above for the spacer segment 62 of the previous design variant applies; in addition, as in the case of the previous design, a rib can be provided.

The construction of the spacer segment 70 from the substrate 70a and the conductor layer 70b allows savings in weight and consumes less conductor material for the same degree of stability of the contact link 68.

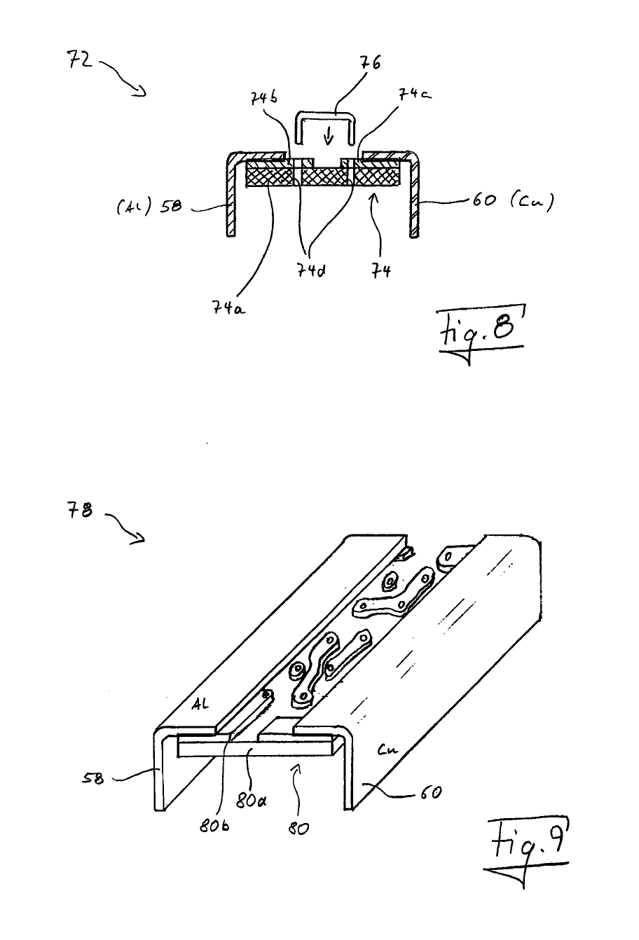

FIG. 8 shows a contact link 72 in another design variant of the present invention in cross-section.

The contact link 72 of this design variant has a first segment 58, a second segment 60 and a spacer segment 74. For the shape, material selection, arrangement and function of the segments 58, 60 and the spacer segment 74, the remarks on the design variant of FIG. 7 can be used as a reference. In particular, the spacer segment 74 in this design variant has a carrier layer (a carrier substrate) 74a and conductor layers 74b, 74c positioned thereon. The conductor layers 74b, 74c extend parallel to a longitudinal axis of the spacer segment 74 and without any conductive connection to each other.

In accordance with the illustration in FIG. 8 the first segment 58 is connected to the first conductor layer 74b, while the second segment 60 is connected to the second conductor layer 74c. In an area outside of the segments 58, 60, holes 74d extend through the conductor layers 74b, 74C and the carrier substrate 74d. In addition, a clip 76 made of an electrically conducting material is provided, which can be inserted into the holes 74d of the first conductor layer 74b and of the second conductor layer 74c and can electrically connect these together.

In this way, battery cells can be connected together via the contact link 72 of this design variant, without an electrical connection being immediately made. The electrical connection can only take place in a later processing step by inserting the clips 76. The battery cells therefore remain electrically isolated from each other until the finishing or final assembly stage, but the mechanical connection between the current connectors is already established.

FIG. 9 shows a contact link 78 of yet another design variant of the present invention, in a schematic perspective view from an end face.

The contact link 78 of this design variant has the segments 58, 60, and also a spacer segment 80. For the segments 58, 60, in terms of function, material, selection, shape and arrangement the remarks made in connection with the previous design variants of FIGS. 6 to 8 apply.

The spacer segment 80 of this design variant is arranged, as are the spacer segments 62, 70, 74 of the above design variants, between the segments 58, 60 and connected thereto. The spacer 80 of this design variant is a printed circuit board with a carrier substrate 80a and a conductor layer 80b. The conductor layer 80b can be for example, applied by printing, have different conductor tracks and contact eyelets, which are indicated only schematically in the figure, without any restrictive significance. On the printed circuit board 80, electronic components (not shown in detail) can be arranged, which serve to control a connection between respective battery cells (not shown in detail) as well as the control of various state variables of the battery cells.

In a variation of this embodiment, a further conductor layer can also be provided on the underside of the carrier substrate 80a, on which electronic components can also be arranged.

Although the present invention has been described above in its essential features by reference to specific exemplary embodiments, it is understood that the invention is not restricted to these exemplary embodiments, but can be varied and extended within the scope and range defined by the claims.

For example, in one variation a bridge can be provided which has a flat shape without angled members, in order to implement a connection between current connectors which are themselves angled.

The battery cells 46 are electrochemical cells in the sense of the present invention. The contact links 44, 56, 68, 72, are contact elements in the sense of the present invention. The segments 40, 58 and 42, 60, and the spacer segments 62, 70, 74, 80 are segments in the sense of the present invention. An arrangement of battery cells 46, 46 shown in FIG. 5 is an arrangement of electrochemical cells in the sense of the invention, wherein this includes any arrangement thereof of any arbitrary number of cells in any desired interconnection of current connectors 48, 50, wherein the current connectors are at least partially connected by means of contact links of the type described above.

The present invention is not only applicable to the connection of current connectors of battery cells, but also to the connection of any arbitrary electrically conducting components made of materials that either cannot, or only unsatisfactorily or with great effort or with inadequate operational reliability, be joined to each other.

### LIST OF REFERENCE LABELS

2 First reel
4 First tape
6 Second reel
8 Second tape
10 First pressure roller
12 First pressure cylinder
14 Second pressure roller
16 Second pressure cylinder
18 First induction heating coil
20 Second induction heating coil
22 Laser source
24 Laser beam
26 Lens
28 Melting zone
30 Semi-finished product
32 First strand
34 Second strand
36 Seam
38 Intermediate product
40 First segment
40a Central member
40b Edge member
41 Deflection curve
42 Second segment
42a Central member
42b Edge member
43 Deflection curve
44 Contact link
46 Battery cell
48 Positive current connector
50 Negative current connector
52 Positive connection point
54 Negative connection point
56 Contact link
58 First segment
60 Second segment
62 Spacer segment
62a Rib
64 First seam
66 Second seam
68 Contact link
70 Spacer segment
70a Carrier substrate
70b Conductor layer
72 Contact link
74 Spacer segment
74a Carrier substrate
74b, 74c Conductor layers
74 Holes
76 Clip
78 Contact link
80 Spacer segment
80a Carrier substrate
80b Conductor layer
L Length

1-14. (canceled)

15. A contact element for connection between current connectors of electrochemical cells, said current connectors including different materials, the contact element comprising:
at least two electrically connected segments,
wherein a first segment is configured to connect to a first of the current connectors, and a second segment is configured to connect to a second of the current connectors.

16. The contact element according to claim 15, wherein the first segment and the first current connector together form a material combination which is adapted to a thermal joining process, and the second segment and the second current connector together form a material combination which is adapted to a thermal joining process.

17. The contact element according to claim 15, wherein at least one of the first and the second segment comprises at least one of an electrically conducting metal or an electrically conducting metal alloy.

18. The contact element according to claim 15, wherein one of the first or the second segment comprises one of aluminum, an aluminum alloy, or a conductor material configured to join to aluminum or an aluminum alloy.

19. The contact element according to claim 18, wherein another of the first and second segment comprises one of copper, a copper alloy, or a material configured to join to copper or copper alloy.

20. The contact element according to claim 15, wherein the first and the second segment are each substantially plate-shaped and include an overlapping seam with each other, and each of the first and second segment is angled on a far side of the seam to form a substantially U-shaped cross-section.

21. The contact element according to claim 15, wherein the first and the second segment are each substantially plate-shaped and include an overlapping seam to overlap each other and to define a common, substantially flat surface, and at least one of the first and second segment is bent at right angles on a far side of the seam.

22. The contact element according to claim 15, wherein the first and second segments are directly adjoined to form an electrically conducting connection.

23. The contact element according to any one of claim 15, wherein the first and the second segments are electrically isolated from each other by at least a third segment, the third segment comprising a non-conducting material, and an electrically conducting connection between the first and the second segment being configured for repeated attachment and detachment.

24. The contact element according to any one of claim 15, wherein the first and the second segments are connected by at least a third segment, arranged between the first and the second segment, and
the third segment has a non-conducting carrier layer and an electrically conducting conductor layer.

25. The contact element according to claim 24, wherein the electrically conducting conductor layer forms a conductor pattern.

26. A method for producing a contact element for connecting between current connectors of electrochemical cells, said current connectors including different materials, the method comprising:
preparing a first electrically conducting segment configured to connect to a first of the current connectors;
preparing a second electrically conducting segment configured to connect to a second of the current connectors; and
joining the first and second segments to each other directly or via at least one other segment,
wherein the first and the second segment form an electrically conducting connection with respect to each other.

27. A method for connecting current connectors of electrochemical cells, said current connectors including different materials, the method comprising:
preparing a contact element including
a first electrically conducting segment configured to connect to a first of the current connectors, and
a second electrically conducting segment configured to connect to a second of the current connectors; and
connecting the first segment to a first current connector to be connected, and connecting the second segment to a second current connector to be connected.

28. An arrangement of electrochemical cells, wherein the electrochemical cells have current connectors which have different conductor materials, wherein current connectors of different cells are connected to contact elements according to claim 15.
